(19) United States
(12) Patent Application Publication
(10) Pub. No.: US 2024/0211894 A1
(43) Pub. Date: Jun. 27, 2024

(54) SCHEDULE INFORMATION PROVIDING METHOD, INFORMATION PROCESSING DEVICE, COMPUTER-READABLE RECORDING MEDIUM RECORDING A PROGRAM, AND COMMUNICATION TERMINAL

(71) Applicant: Panasonic Intellectual Property Corporation of America, Torrance, CA (US)

(72) Inventors: Takeshi NONAKA, Chiba (JP); Yoshihiko TAKEI, Kanagawa (JP)

(73) Assignee: Panasonic Intellectual Property Corporation of America, Torrance, CA (US)

(21) Appl. No.: 18/601,306

(22) Filed: Mar. 11, 2024

Related U.S. Application Data
(63) Continuation of application No. PCT/JP2022/028783, filed on Jul. 26, 2022.

(30) Foreign Application Priority Data
Sep. 14, 2021 (JP) 2021-149677

(51) Int. Cl. G06Q 10/1093

(52) U.S. Cl. CPC G06Q 10/1095

(57) ABSTRACT

An information processing device performs: acquiring event information including a condition of a target user who executes an event; creating, on the basis of the acquired event information, schedule information indicating an event planned to be executed; acquiring response information from the target user as to whether the event included in the event information can be executed or not; updating, on the basis of the acquired response information, the schedule information to indicate the event which can be executed; and outputting the updated schedule information.

### FIELD OF INVENTION

The present disclosure relates to a method for providing schedule information, an information processing device, a computer-readable recording medium recording a program, and a communication terminal.

### BACKGROUND ART

Patent Literature 1 discloses a technology of generating a collaborative schedule as a feasible schedule selected by a plurality of members.

However, Patent Literature 1 fails to consider updating schedule information on the basis of response information from a planned executer as to whether the schedule can be executed or not.

Patent Literature 1: Japanese Patent Publication No. 6852610

### SUMMARY OF THE INVENTION

The present disclosure has an object of providing a method for providing schedule information, an information processing device, a computer-readable recording medium recording a program, and a communication terminal to enable updating of schedule information on the basis of response information from a target user.

A method for providing schedule information according to an aspect of the present disclosure includes: by an information processing device, acquiring event information including a condition of a target user who executes an event; creating, on the basis of the acquired event information, schedule information indicating an event planned to be executed; acquiring response information from the target user as to whether the event included in the event information can be executed or not; updating, on the basis of the acquired response information, the schedule information to indicate the event which can be executed; and outputting the updated schedule information.

### BRIEF DESCRIPTION OF THE DRAWINGS

FIG. 1 is a simplified diagram showing an overall configuration of a schedule information management system.

FIG. 2 is a flowchart schematically showing a sequence of a process executed by an information processor.

FIG. 3 is a table showing an example of simplified event information.

FIG. 4 is a table showing an example of simplified list information.

FIG. 5 is an illustration of an example of a simplified input screen image of response information.

FIG. 6 is a table showing an example of simplified and updated list information.

FIG. 7 is a table showing an example of simplified individual information.

FIG. 8 is an illustration of an example of a simplified input screen image of response information.

FIG. 9 is a table showing an example of simplified event information.

### DETAILED DESCRIPTION

### Knowledge Forming the Basis of the Present Disclosure

A family or other group including a plurality of users living together finds it convenient to share act schedules of the respective users as digital data among all the users. Patent Literature 1 discloses a technology of generating and managing, as a collaborative schedule, each act schedule of each member belonging to a group including a plurality of members.

However, even when schedule information indicating an event planed to be executed is created by a certain user through a manipulation input, the event may not be executed due to a circumstance of another user. However, the background art has no mechanism to facilitate modification of the created schedule information depending on a circumstance of each user. Patent Literature 1 also fails to consider updating the schedule information on the basis of response information from a planned executer as to whether the schedule can be executed or not.

To solve the drawbacks, the present inventor has obtained the knowledge that creating schedule information indicating an event planned to be executed or not, thereafter acquiring response information from a target user as to whether the event can be executed, and updating the schedule information on the basis of the acquired response information lead to an achievement in facilitated modification of the schedule information depending on a circumstance of the user, and then, the present inventor has conceived of the present disclosure.

Hereinafter, features of the present disclosure will be described.

A method for providing schedule information according to a first feature of the present disclosure includes: by an information processing device, acquiring event information including a condition of a target user who executes an event; creating, on the basis of the acquired event information, schedule information indicating an event planned to be executed; acquiring response information from the target user as to whether the event included in the event information can be executed or not; updating, on the basis of the acquired response information, the schedule information to indicate the event which can be executed; and outputting the updated schedule information.

In the first feature, response information from a target user as to whether an event can be executed or not is acquired, and schedule information is updated on the basis of the response information to indicate the event which can be executed. This enables facilitated modification of the schedule information depending on a circumstance of the target user.

With a method for providing schedule information according to a second feature of the disclosure, in the first feature, there is a plurality of target users, and the information processing device may further acquire, from all the users, response information indicating that an event can be executed by the users, and determine that the event can be executed.

Even when the target user includes a plurality of users, the second feature enables facilitated modification of the schedule information depending on a circumstance of each of the users.

With a method for providing schedule information according to a third feature of the disclosure, in the second feature, the schedule information may include list information indicating a list of a plurality of events which can be executed by the users.

The third feature in which the schedule information includes the list information enables all the users to share the schedule information about the users.

With a method for providing schedule information according to a fourth feature of the disclosure, in the third feature, the schedule information may further include individual information indicating an event which can be executed by each of the users.

The fourth feature in which the schedule information includes the individual information enables each user to easily confirm the schedule thereof.

With a method for providing schedule information according to a fifth feature of the disclosure, in any one of the first to fourth features, the information processing device may further give, in the schedule information, a mark showing schedule unsettlement to an event planned to be executed and a mark showing schedule settlement to an event which can be executed.

The fifth feature enables distinction between an event with schedule unsettlement and an event with schedule settlement in the schedule information.

With a method for providing schedule information according to a sixth feature of the disclosure, in any one of the first to fifth features, the information processing device may further execute: acquiring, in the acquiring of the response information, response information from a substituting user who executes the event in substitution for the target user; and updating, when the response information indicating that the event can be executed is acquired from the substituting user in the updating of the schedule information, the schedule information on the basis of the response information to indicate the event which can be executed.

The sixth feature enables acquisition of the response information from the substituting user, and thus achieves an increase in the possibility that the event can be executed.

With a method for providing schedule information according to a seventh feature of the disclosure, in the sixth feature, the event information may further include a condition of the substituting user.

The seventh feature in which the event information includes the condition of the substituting user enables setting of the condition of the substituting user in the event information.

An information processing device according to an eighth feature of the disclosure includes: an acquisition part that acquires event information including a condition of a target user who executes an event and response information from the target user as to whether the event included in the event information can be executed or not; a processing part that creates, on the basis of the event information acquired by the acquisition part, schedule information indicating an event planned to be executed, and updates, on the basis of the response information acquired by the acquisition part, the schedule information to indicate the event which can be executed; and an output part that outputs the schedule information updated by the processing part.

In the eighth feature, response information from a target user as to whether an event can be executed or not is acquired, and schedule information is updated on the basis of the response information to indicate the event which can be executed. This enables facilitated modification of the schedule information depending on a circumstance of the target user.

A program according to a ninth feature of the disclosure includes: causing an information processing device to serve as: an acquisition part that acquires event information including a condition of a target user who executes an event and response information from the target user as to whether the event included in the event information can be executed or not; a processing part that creates, on the basis of the event information acquired by the acquisition part, schedule information indicating an event planned to be executed, and updates, on the basis of the response information acquired by the acquisition part, the schedule information to indicate the event which can be executed; and an output part that outputs the schedule information updated by the processing part.

In the ninth feature, response information from a target user as to whether an event can be executed or not is acquired, and schedule information is updated on the basis of the response information to indicate the event which can be executed. This enables facilitated modification of the schedule information depending on a circumstance of the target user.

A method for providing schedule information according to a tenth feature of the present disclosure includes: by a communication terminal, receiving schedule information indicating an event planned to be executed from an information processing device and displaying the received schedule information on a display part, the schedule information having been created by the information processing device on the basis of event information including a condition of a target user who executes the event; receiving response information from the target user as to whether the event included in the event information can be executed or not, and transmitting the response information to the information processing device; and receiving, from the information processing device, the schedule information updated by the information processing device on the basis of the response information to indicate the event which can be executed, and displaying the received schedule information on the display part.

In the tenth feature, the information processing device receives response information from a target user as to whether an event can be executed or not, and updates, on the basis of the response information, schedule information to indicate the event which can be executed. This enables facilitated modification of the schedule information depending on a circumstance of the target user.

A communication terminal according to an eleventh feature of the present disclosure includes: a communication part, a display part; and an input part. The communication part receives schedule information indicating an event planned to be executed from an information processing device, and the display part displays the received schedule information, the schedule information having been created by the information processing device on the basis of event information including a condition of a target user who executes the event. The input part receives an input of response information from the target user as to whether the event included in the event information can be executed or not, and the communication part transmits the response information to the information processing device. The communication part receives, from the information processing device, the schedule information updated by the information processing device on the basis of the response information to indicate the event which can be executed, and the display part displays the received schedule information.

In the eleventh feature, the information processing device receives response information from a target user as to whether an event can be executed or not, and updates, on the basis of the response information, schedule information to indicate the event which can be executed. This enables facilitated modification of the schedule information depending on a circumstance of the target user.

This disclosure can be realized as a program for causing a computer to execute each distinctive feature included in such a method or a device described above, or realized as a system caused to operate by the program. Additionally, it goes without saying that the computer program is distributable as a non-transitory computer readable storage medium like a CD-ROM, or distributable via a communication network like the Internet.

### Embodiment of the Present Disclosure

Hereinafter, an embodiment of the disclosure will be described with reference to the accompanying drawings. The elements given the same reference numerals in different drawings are defined to be the same or corresponding elements. Further, constituent elements, arrangement and connection of the constituent elements, an operation order, and the like shown in the embodiment described below are mere examples, and do not intend to limit the present disclosure. The present disclosure is defined by the scope of claims. Moreover, constituent elements which are not recited in the independent claims each showing the broadest concept among the constituent elements in the embodiment are not indispensable to achieve the object of the present disclosure but are described as selectable constituent elements for a more preferable configuration.

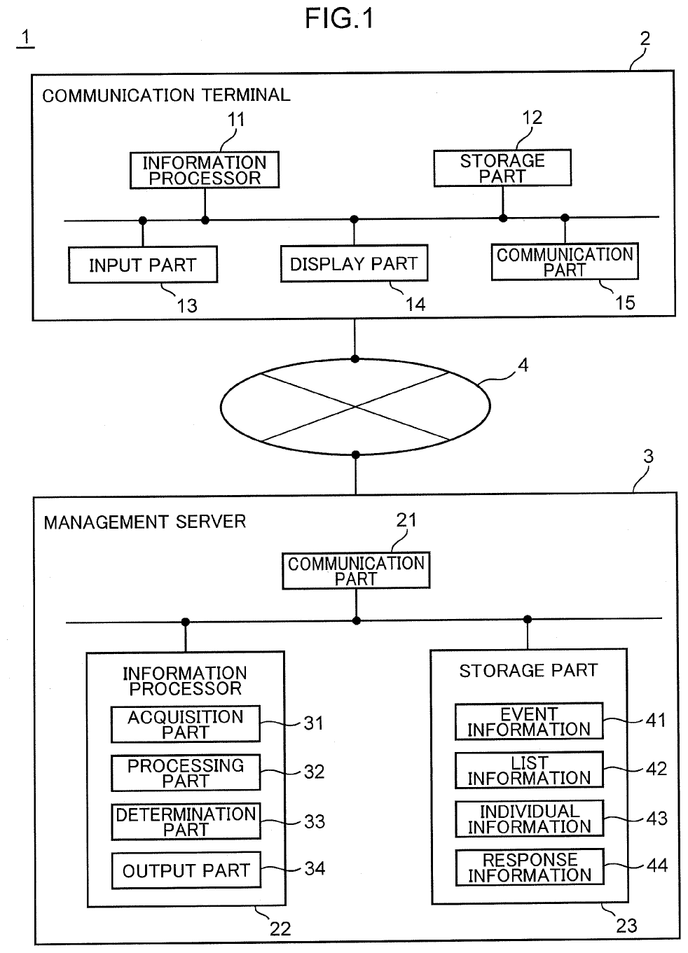

FIG. 1 is a simplified diagram showing an overall configuration of a schedule information management system 1 in an embodiment of the present disclosure. The schedule information management system 1 includes a communication terminal 2 and a management server 3. The communication terminal 2 and the management server 3 are communicable with each other via a communication network 4. The communication network 4 includes, for example, a special circuit network or a public switched telephone network suitable for a specific communication protocol, such as the IP.

The communication terminal 2 is, for example, a smartphone. The communication terminal 2 includes an information processor 11, a storage part 12, an input part 13, a display part 14, and a communication part 15. The information processor 11 includes, for example, a CPU. The storage part 12 includes a flush memory or other memory. The input part 13 and the display part 14 include a monitor of a touch screen type using an LCD, an organic EL, or other way. The communication part 15 includes a communication module suitable for the appropriate communication protocol, such as the IP. Each of the storage part 12, the input part 13, and the display part 14 may be a device configured independently of the communication terminal 2.

The management server 3 includes a cloud server, an edge server, or other server. The management server 3 includes a communication part 21, an information processor 22, and a storage part 23. The communication part 21 includes a communication module suitable for the appropriate communication protocol, such as the IP. The information processor 22 includes, for example, a CPU. The storage part 23 includes an HDD, an SSD, a flush memory, or other memory. The storage part 23 may be a device configured independently of the management server 3.

The information processor 22 operatively has an acquisition part 31, a processing part 32, a determination part 33, and an output part 34 each realized when the CPU executes a program read out to a ROM or a RAM from the storage part 23. In other words, the program causes the information processor 22 mounted on the management server 3 serving as the information processing device to operate as these processing parts.

The storage part 23 stores event information 41, list information 42, individual information 43, and response information 44.

The event information 41 indicates an event which is executed by a target user. The event information in the embodiment further includes an event ID identifying the event, a target user ID identifying the user who executes the event, and information indicating correspondence therebetween. The event includes a household task, an affair, an activity, and other matter related to a life or an act of the target user. The event includes affairs or events related to the life, such as taking-out of rubbish, an after-school activity, and bank transfer. The event further includes family events, such as a family trip, eating-out, and other event. The event further includes school events, such as an entrance ceremony, a graduation ceremony, and preparation for gym cloths. The event in this disclosure further includes a task required to be executed by the target user, such as the taking-out of rubbish or the bank transfer.

The event information 41 includes a database including a plurality of records, and each record is associated with one event. Each record includes a field for the event ID and a field for the target user ID. Each record may further include a field for a planned date and time for an event and a field for an event name.

The list information 42 indicates an event associated with a target user in a predetermined period. When the target user includes a plurality of target users, the list information 42 shows a list of collected events of the users. The predetermined period may be an appropriate period, such as one month or one week.

The list information 42 includes a database including a plurality of records, and each record is associated with a unit period. Examples of the unit period include one day. Each record in the list information 42 includes a field for an event ID, a field for a target user ID, a field for flag information about schedule unsettlement or schedule settlement, a field for a planned date and time, and a field for an event name.

The individual information 43 indicates an event of each user in the predetermined period. The individual information 43 includes a database including a plurality of records, and each record is associated with the unit period. Each record in the individual information 43 includes a field for an event ID, a field for a planned date and time for the event, and a field for an event name.

The response information 44 indicates a response content from a user as to whether an event can be executed or not. The response information 44 includes an event ID, a user ID of the user having responded, and the response content indicating whether the event can be executed or not.

The acquisition part 31 acquires the event information 41 and the response information 44 from the storage part 23. The processing part 32 creates, on the basis of the event information 41 acquired by the acquisition part 31, the list information 42 indicating an event planned to be executed, and updates, on the basis of the response information 44 acquired by the acquisition part 31, the list information 42 to indicate the event which can be executed. The determination part 33 determines whether the response information 44 about each event is acquired from every target user or all the target users. The output part 34 outputs the list information 42 updated by the processing part 32. The storage part 23 stores the list information 42 output by the output part 34.

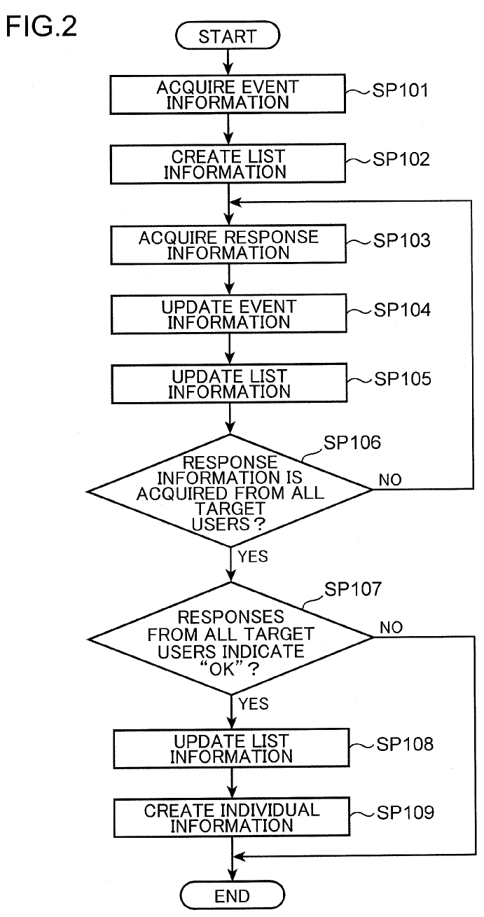

FIG. 2 is a flowchart schematically showing a sequence of a process executed by the information processor 22. Hereinafter, for instance, schedule management aiming at a family group consisting of four users as target users, i.e., a father, a mother, an elder sister, and a younger brother, will be described. Each user has his or her own communication terminal 2, and the management server 3 can identify each communication terminal 2 by using unique identification information given to each communication terminal 2.

The user inputs event information 41 by manipulating the input part 13. Specifically, a specific user, e.g., a user who has an event to be executed, among a plurality of users inputs an event name, a planned date and time for the relevant event, and a target user who executes the event into schedules of all the users in the predetermined period. The information processor 11 gives an event ID to thethe input event. The information processor 11 creates a record including an event ID, a target user ID, a planned date and time, and an event name per input event, and generates event information 41 including a plurality of records associated with a plurality of events. The communication part 15 transmits the input event information 41 to the management server 3 via the communication network 4. The communication part 21 stores the received event information 41 in the storage part 23. In step SP101, the acquisition part 31 acquires the event information 41 from the storage part 23. The management server 3 may receive event information 41 from an external server which manages calendar information already registered through a calendar application in addition to the event information 41 from the communication terminal 2.

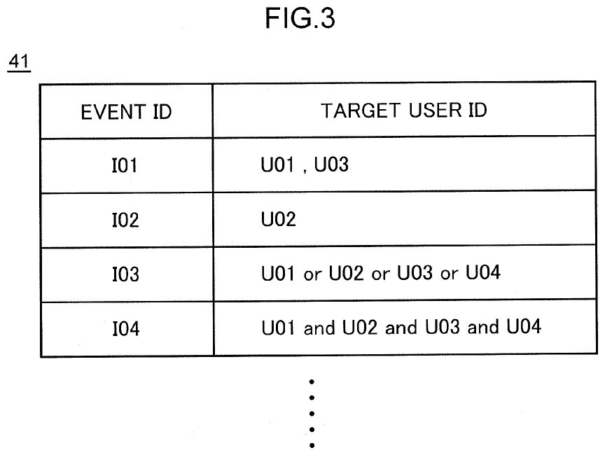

FIG. 3 is a table showing an example of simplified event information 41. The event information 41 includes an event ID and a target user ID as described above. The event ID represents unique identification information given to each event, and the example here shows I01 to I04. The user ID represents unique identification information given to each user, and the example shows U01 for the father, U02 for the mother, U03 for the elder sister, and U04 for the younger brother. The target user ID is a user ID showing a condition of a target user designated as a user who executes the event.

Regarding the event having the event ID I01, the user IDs U01 and U03 are set as target user IDs. Regarding the event having the event ID I02, the user ID U02 is set as a target user ID.

Regarding the event having the event ID I03, the user ID U01, U02, U03, or U04, i.e., an appropriate member in a family, is set as the target user ID. Regarding the event having the event ID I04, all the user IDs U01, U02, U03, and U04, i.e., all the members in the family, are set as target user IDs.

Although FIG. 3 omits illustration, the event information 41 includes information indicating a planned date and time for an event and information indicating a content of the event.

In the subsequent step S102, the processing part 32 arranges a plurality of events included in the event information 41 acquired in step SP101 in the predetermined period collectively for a unit period, and creates list information 42 or schedule information indicating an event planned to be executed. The processing part 32 stores the created list information 42 in the storage part 23.

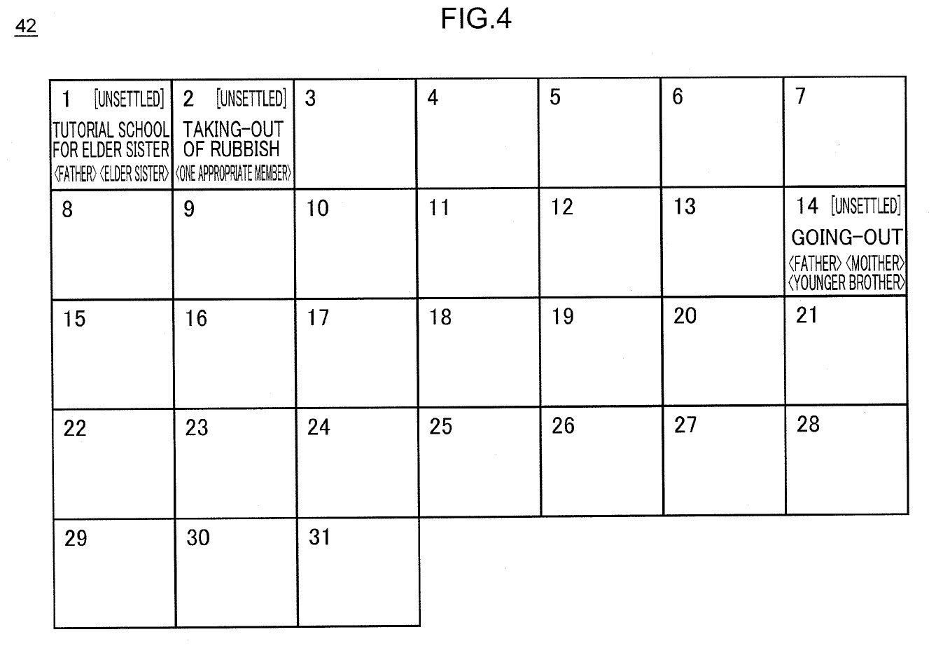

FIG. 4 is a table showing an example of simplified list information 42 created in step SP102. The example shows a list of events in a calendar format of a certain month from the first to the thirty first dates of the month. A cell expressing the first date shows an event name “tutorial school for elder sister”, a mark indicating the father and the elder sister as response needed users about the relevant event, and another mark indicating schedule unsettlement. The mark indicating the schedule unsettlement is, for example, “unsettled”. Alternatively, the cell may have a blank space to confirm the unsettlement without displaying a mark of, for example, “settled” indicating schedule settlement.

The processing part 32 extracts an event planned to be executed on a planned date that is the first date from the event information 41, and writes the event name (“tutorial school for elder sister” in the example) of the relevant event and a user name associated with a target user ID for the event (each of “father” and “elder sister” in the example) in the cell expressing the first date in the list information 42. The target user in the event information 41 corresponds to a response needed user in the list information 42. The processing part 32 writes the mark “unsettled” indicating the schedule unsettlement in the cell expressing the first date in the list information 42. A cell expressing the second date shows an event name “taking-out of rubbish”, a mark indicating “one appropriate member” representing one appropriate member in the family as the response needed user about the relevant event, and another mark “unsettled” indicating schedule unsettlement. A cell expressing the fourteenth date shows an event name “going-out”, a mark indicating the father, the mother, and the younger brother as response needed users about the relevant event, and another mark “unsettled” indicating schedule unsettlement.

The communication part 21 transmits data of the list information 42 read out from the storage part 23 to the communication terminal 2 to enable the display part 14 of the communication terminal 2 to display the list information 42.

Each user designated as the response needed user in the list information 42 inputs response information 44 as to whether the event can be executed or not by manipulating the input part 13. The communication part 15 transmits the input response information 44 to the management server 3 via the communication network 4. The response information 44 includes an event ID, a user ID of the user having responded, and a response content indicating whether the event can be executed or not. The communication part 21 stores the received response information 44 in the storage part 23. In step SP103, the acquisition part 31 acquires the response information 44 from the storage part 23.

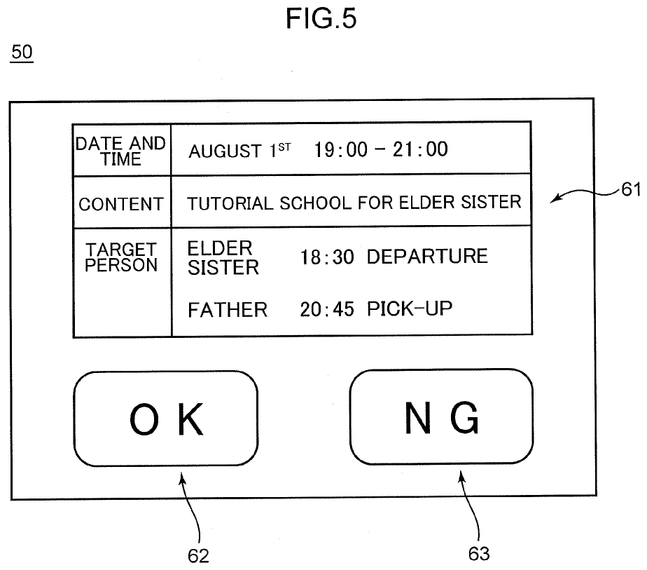

FIG. 5 is an illustration of an example of a simplified input screen image 50 of the response information 44 displayed on the display part 14. For example, the processing part 32 of the management server 3 causes the display part 14 of the communication terminal 2 to display the input screen image 50 shown in FIG. 5 thereon in a pop-up manner in response to tapping of the cell expressing the first date in the list information 42 by each user (each of the father and the elder sister) designated as the response needed user about the event “tutorial school for elder sister”. The input screen image 50 includes: an item 61 showing a date and time for the event, a content thereof, and a target person or target user; an OK button 62 to be tapped when the event can be executed; and an NG button 63 to be tapped when the event cannot be executed. The input part 13 receives an input of the response information 44 in response to tapping of either the OK button 62 or the NG button 63 by the target user.

Next, in step SP104, the processing part 32 updates the event information 41 on the basis of the response information 44 acquired in step SP103 and stores the updated event information 41 in the storage part 23. Specifically, the processing part 32 updates the event information 41 to exclude the user whose response information 44 indicating that the event can be executed from response needed about the event. For instance, regarding the event for which response needed users include the father and the elder sister in the event information 41, when the response information 44 indicating that the event can be executed is acquired from the father, the processing part 32 updates the event information 41 to exclude the father from the response needed users.

Then, in step SP105, the processing part 32 updates the list information 42 on the basis of the event information 41 updated in step SP104 and stores the updated list information 42 in the storage part 23. Specifically, the processing part 32 collectively arranges a plurality of events included in the updated event information 41 in the predetermined period to create the updated list information 42.

Subsequently, in step SP106, the determination part 33 determines whether the response information 44 is acquired from all the target users about each event.

When there is a user who does not respond about an event (NO in step SP106), the steps from step SP103 are repetitively executed for the event.

When the response information 44 is acquired from all the target users about each event (YES in step SP106), the determination part 33 determines whether the responses from all the target users about the event indicate “OK” in the subsequent step SP107. Here, regarding an event for which a target user ID defined by each of a plurality of user IDs expressed with “or” like the event associated with the event ID “I03” in the event information 41 shown in FIG. 3, the determination part 33 executes a process to be described below. The determination part 33 determines whether response information 44 not from all the target users but from any one of the users is acquired in step SP106, and determines whether the response from the one target user indicates “OK” in step SP107 instead of the responses from all the target users.

When a response from a certain user indicates “NG” or unacceptable about an event (NO in step SP107), the process for the event is finished.

When responses from all the target users indicate “OK” about each event (YES in step SP107), the processing part 32 settles the schedule for the event, and updates the list information 42 to indicate that the event can be executed in the subsequent step SP108. The processing part 32 stores the updated list information 42 in the storage part 23.

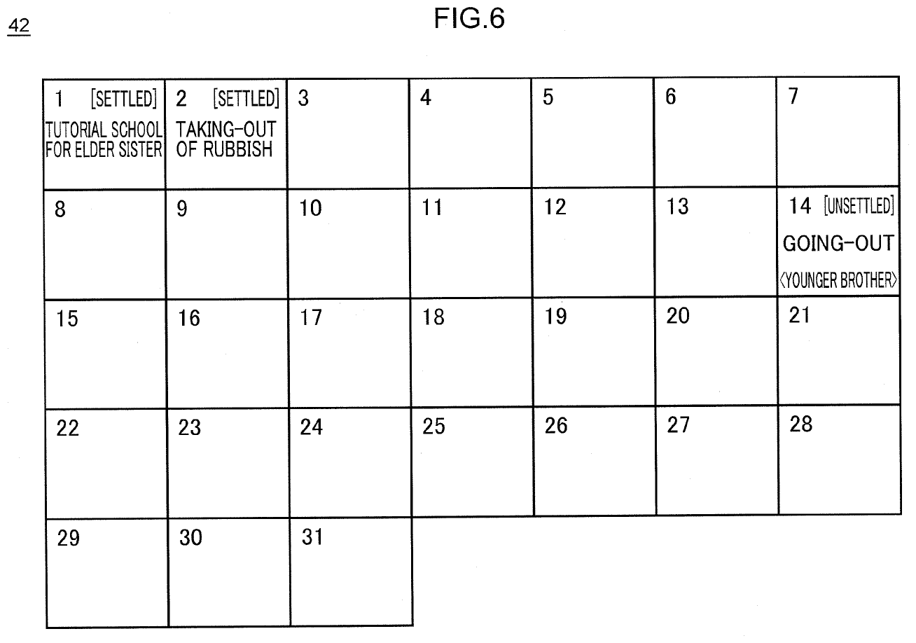

FIG. 6 is a table showing an example of simplified list information 42 updated in step SP108. In this example, a cell expressing the first date includes: an event name “tutorial school for elder sister”; and a mark, e.g., “settled”, indicating schedule settlement for responses indicating “OK” from all the target users (the father and the elder sister) about the event. The processing part 32 settles the schedule for the event when response information 44 is acquired from all the target users (the father and the elder sister) about the event having the event name “tutorial school for elder sister” and the responses of the target users indicate “OK”. The processing part 32 writes the mark “settled” indicating the schedule settlement for the event in the cell expressing the first date in the list information 42. A cell expressing the second date shows the event name “taking-out of rubbish” and the mark “settled” indicating the schedule settlement in response to the response indicating “OK” from a target user (one appropriate member) about the relevant event. A cell expressing the fourteenth date shows the event name “going-out”, a mark defining the younger brother as a response needed user about the event, and the mark “unsettled” indicating the schedule unsettlement. It is noted here that the father and the mother are excluded from response needed users owing to their responses indicating “OK”.

The communication part 21 transmits data of the updated list information 42 read out from the storage part 23 to the communication terminal 2 to enable the display part 14 of the communication terminal 2 to display the updated list information 42.

Next, in step SP109, the processing part 32 collectively arranges a plurality of events included in the updated list information 42 in the predetermined period per user to create individual information 43 indicating an event which can be executed about each user. The processing part 32 stores the created individual information 43 in the storage part 23.

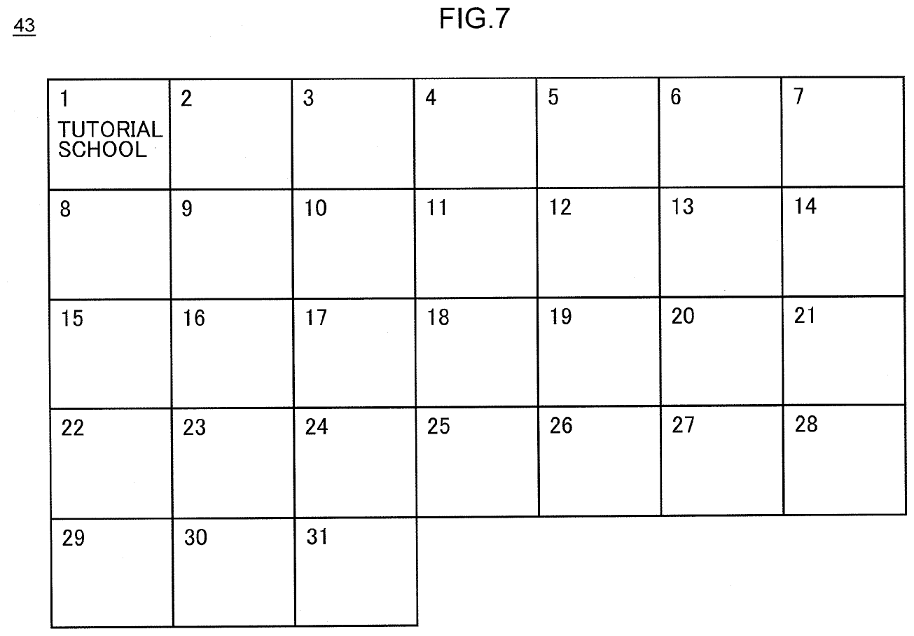

FIG. 7 is a table showing an example of simplified individual information 43. This example shows individual information 43 about the elder sister. A cell expressing the first date shows an event name “tutorial school” which has been settled.

The communication part 21 transmits data of the individual information 43 read out from the storage part 23 to the communication terminal 2 to enable the display part 14 of the communication terminal 2 to display the individual information 43.

In the embodiment, the information processor 22 acquires response information 44 from a target user as to whether an event can be executed or not, updates, on the basis of the response information 44, list information 42 or schedule information to indicate the event which can be executed. This enables facilitated modification of the list information 42 depending on a circumstance of the target user.

Besides, even when the target user includes a plurality of users, the embodiment enables facilitated modification of the list information 42 depending on a circumstance of each of the users.

The embodiment in which the schedule information includes the list information 42 permits all the users to share the schedules of the users. The distinctive display between unsettlement and settlement in the list information 42 for each event enables each user to grasp a settlement situation or an unsettlement situation for each event and perform task management therefor.

The embodiment in which the schedule information includes the individual information 43 enables each user to easily confirm the schedule thereof.

### Modifications

In the embodiment, when a response from a specific user about a certain event indicates “NG” (NO in step SP107), the process about the event is finished. Instead, response information 44 may be acquirable from a substituting user who substitutes for the target user whose response indicates “NG”.

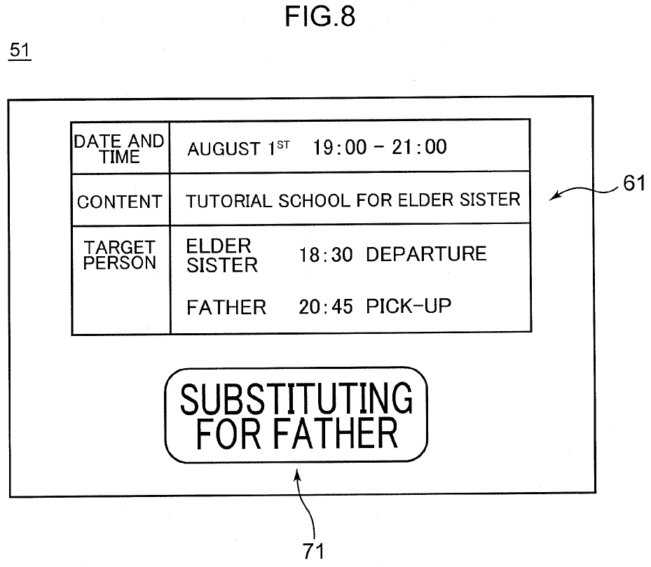

In an example described below, a substituting user substitutes for a target user whose response indicates “NG” on the substituting user's own will. FIG. 8 is an illustration of an example of a simplified input screen image 51 of response information 44 displayed on a display part 14 of a communication terminal 2 owned by the substituting user. For example, the processing part 32 of the management server 3 causes the display part 14 of the communication terminal 2 to display the input screen image 51 shown in FIG. 8 thereon in a pop-up manner in response to tapping of a cell expressing the first date in list information 42 shown in FIG. 4 by a substituting user (mother) in substitution for a user (father) designated as a response needed user about an event “tutorial school for elder sister”. The input screen image 51 includes: an item 61 showing a date and time for the event, a content thereof, and a target person or target user; and a substitute button 71 to be tapped when the event can be executed owing to the substitution. The substitute button 71 shows a text message (“substituting for father” in this example) indicating the substitution for the target user whose response indicates “NG”. The substituting user taps the substitute button 71 to input the response information 44 indicating “substitution OK” into the input part 13. In this case, the response information 44 includes an event ID, a user ID of the substituting user having inputted the response, and a response content.

When the acquisition part 31 acquires the response information 44 indicating “substitution OK”, the processing part 32 updates the event information 41 on the basis of the response information 44 and stores the updated event information 41 in the storage part 23. Specifically, the processing part 32 executes updating of excluding a substituted user (the father in the example) having been substituted by the substituting user (the mother in the example) from response needed users about the event. The processing part 32 settles the schedule for the event when acquiring response information 44 indicating “OK” from every target user and the substituting user about the event, and updates the list information 42 to indicate that the event can be executed in the same manner as that in FIG. 6. The processing part 32 further stores the updated list information 42 in the storage part 23.

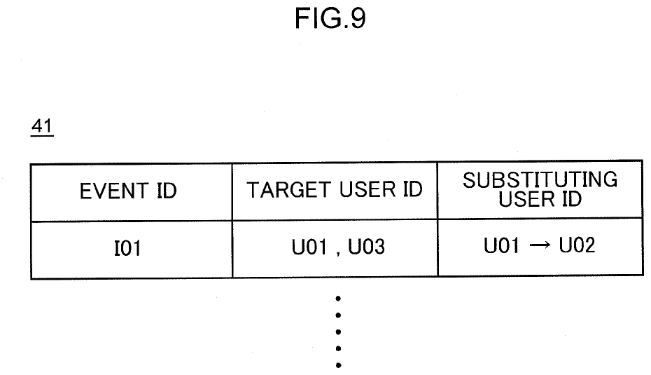

The event information 41 may include a condition of the substituting user. For instance, a user who inputs event information 41 may set a specific user as a substituting user and set a user ID of each of a substituted user and the substituting user as a condition of the substituting user. FIG. 9 is a table showing an example of simplified event information 41. The event information 41 includes an event ID, a target user ID, and the substituting user ID. The substituting user ID includes a user ID (U01 in the example) of the substituted user and a user ID (U02 in the example) of the substituting user. In FIG. 9, the event is associated with the event ID I01, and target users about the event are associated with user IDs U01 and U03. The notice “U01U→02” in the column of the substituting user ID shows the user ID of the substituted user as “U01” and the user ID of the substituting user as “U02”.

When the event information 41 includes another user (e.g., the younger brother associated with a user ID U04) who is not set as a substituting user, the processing part 32 keeps a display part 14 of a communication terminal 2 owned by another user from displaying an input screen image 51 for substitution to avoid permitting the substitution about the event.

Alternatively, the processing part 32 may permit a user set as the substituting user in the event information 41 to substitute under the condition of receiving the response information 44 indicating “NG” from the communication terminal 2 of the substituted user, or permit the substitution regardless of receiving or non-receiving of the response information 44 from the communication terminal 2 of the substituted user. In the former case, the processing part 32 may transmit, from the management server 3 to a communication terminal 2 of a substituted user, message information indicating a request for substitution made to the substituting user. In the latter case, the processing part 32 may transmit, from the management server 3 to a communication terminal 2 of a substituted user, confirmation message about acceptance or non-acceptance of the substitution.

The modification enables acquisition of the response information 44 from the substituting user, and thus achieves an increase in the possibility that the event can be executed.

Besides, the modification in which the event information 41 includes a condition of the substituting user achieves facilitated setting and management of the condition of the substituting user.

The present disclosure is particularly effectively applicable to a schedule management system including a communication terminal and a server device.

1. A method for providing schedule information, comprising:
by an information processing device,
acquiring event information including a condition of a target user who executes an event;
creating, on the basis of the acquired event information, schedule information indicating an event planned to be executed;
acquiring response information from the target user as to whether the event included in the event information can be executed or not;
updating, on the basis of the acquired response information, the schedule information to indicate the event which can be executed; and
outputting the updated schedule information, wherein
the event information includes information indicating the event executed by the target user, and further includes a database including a plurality of records,
each of the records including a field for an event ID identifying the event planned to be executed and a field for a target user ID identifying the target user who is to execute the event.

2. The method for providing schedule information according to claim 1, wherein there is a plurality of target users, the method further comprising
acquiring, from all the users, response information indicating that an event can be executed by the users, and determining that the event can be executed.

3. The method for providing schedule information according to claim 2, wherein the schedule information includes list information indicating a list of a plurality of events which can be executed by the users.

4. The method for providing schedule information according to claim 3, wherein the schedule information further includes individual information indicating an event which can be executed by each of the users.

5. The method for providing schedule information according to claim 1, further comprising giving, in the schedule information, a mark showing schedule unsettlement to an event planned to be executed and a mark showing schedule settlement to an event which can be executed.

6. The method for providing schedule information according to claim 1, wherein,
in the acquiring of the response information, response information from a substituting user who executes the event in substitution for the target user is acquired; and,
in the updating of the schedule information, when the response information indicating that the event can be executed is acquired from the substituting user, the schedule information is updated on the basis of the response information to indicate the event which can be executed.

7. The method for providing schedule information according to claim 6, wherein the event information further includes a condition of the substituting user.

8. An information processing device, comprising:
an acquisition part that acquires event information including a condition of a target user who executes an event and response information from the target user as to whether the event included in the event information can be executed or not;
a processing part that creates, on the basis of the event information acquired by the acquisition part, schedule information indicating an event planned to be executed, and updates, on the basis of the response information acquired by the acquisition part, the schedule information to indicate the event which can be executed; and
an output part that outputs the schedule information updated by the processing part, wherein
the event information includes information indicating the event executed by the target user, and further includes a database including a plurality of records,
each of the records including a field for an event ID identifying the event planned to be executed and a field for a target user ID identifying the target user who is to execute the event.

9. A computer-readable recording medium recording a program for causing an information processing device to perform processing, comprising:
acquiring event information including a condition of a target user who executes an event;
creating, on the basis of the acquired event information, schedule information indicating an event planned to be executed;
acquiring response information from the target user as to whether the event included in the event information can be executed or not;
updating, on the basis of the acquired response information, the schedule information to indicate the event which can be executed; and
outputting the updated schedule information, wherein
the event information includes information indicating the event executed by the target user, and further includes a database including a plurality of records,
each of the records including a field for an event ID identifying the event planned to be executed and a field for a target user ID identifying the target user who is to execute the event.

10. A method for providing schedule information, comprising:
by a communication terminal,
receiving schedule information indicating an event planned to be executed from an information processing device and displaying the received schedule information on a display part, the schedule information having been created by the information processing device on the basis of event information including a condition of a target user who executes the event;
receiving response information from the target user as to whether the event included in the event information can be executed or not, and transmitting the response information to the information processing device; and
receiving, from the information processing device, the schedule information updated by the information processing device on the basis of the response information to indicate the event which can be executed, and displaying the received schedule information on the display part, wherein
the event information includes information indicating the event executed by the target user, and further includes a database including a plurality of records,
each of the records including a field for an event ID identifying the event planned to be executed and a field for a target user ID identifying the target user who is to execute the event.

11. A communication terminal, comprising:
a communication part,
a display part; and
a display part, wherein
the communication part receives schedule information indicating an event planned to be executed from an information processing device, and the display part displays the received schedule information, the schedule information having been created by the information processing device on the basis of event information including a condition of a target user who executes the event,
the input part receives an input of response information from the target user as to whether the event included in the event information can be executed or not, and the communication part transmits the response information to the information processing device, and
the communication part receives, from the information processing device, the schedule information updated by the information processing device on the basis of the response information to indicate the event which can be executed, and the display part displays the received schedule information, wherein
the event information includes information indicating the event executed by the target user, and further includes a database including a plurality of records,
each of the records including a field for an event ID identifying the event planned to be executed and a field for a target user ID identifying the target user who is to execute the event.
